(19) United States
(12) Patent Application Publication
(10) Pub. No.: US 2013/0120905 A1
(43) Pub. Date: May 16, 2013

(54) MULTILAYERED CERAMIC ELECTRONIC COMPONENT AND METHOD OF FABRICATING THE SAME

(71) Applicants: Soo Hwan Son, Seoul (KR); Byeong Cheol Moon, Seoul (KR); So Yeon Song, Seongnam (KR)

(72) Inventors: Soo Hwan Son, Seoul (KR); Byeong Cheol Moon, Seoul (KR); So Yeon Song, Seongnam (KR)

(73) Assignee: SAMSUNG ELECTRO-MECHANICS CO., LTD

(21) Appl. No.: 13/351,844

(22) Filed: Jan. 17, 2012

(30) Foreign Application Priority Data
Nov. 10, 2011 (KR) 10-2011-0116860

(51) Int. Cl. H01G 4/12; B05D 5/12; B05D 1/36; H01F 5/00

(52) U.S. Cl. 361/321.2; 336/200; 427/58; 427/126.6; 427/123; 427/125

(57) ABSTRACT

There are provided a multilayered ceramic electronic component and a method of fabricating the same. The multilayered ceramic electronic component includes: a ceramic main body; external electrodes; and inner conductors forming a structure of a coil within the ceramic main body, wherein a central axis of the coil is in parallel to the direction in which the external electrodes are connected, and the inner conductors include via conductors laminated to be perpendicular to the central axis of the coil and a ratio of the area of one face of the via conductor to the area of the other face of the via conductor ranges from 0.9 to 1.1.

### CROSS-REFERENCE TO RELATED APPLICATIONS

This application claims the priority of Korean Patent Application No. 10-2011-0116860 filed on Nov. 10, 2011, in the Korean Intellectual Property Office, the disclosure of which is incorporated herein by reference.

### BACKGROUND OF THE INVENTION

1. Field of the Invention

The present invention relates to a multilayered ceramic electronic component and, more particularly, to a multilayered ceramic electronic component having excellent DC resistance characteristics and impedance characteristics and a method of fabricating the same at low cost and with high productivity.

2. Description of the Related Art

A multilayered inductor includes an electrically connected coil structure within a magnetic main body, and the coil structure may be configured by being connected to a conductive pattern.

In multilayered inductors, when a central axis of the coil is perpendicular to a direction in which external electrodes are extendedly connected, parasitic capacitance may be formed between internal and external electrodes, resulting in a degradation of inductor RF characteristics.

In an effort to solve this defect, a structure in which the central axis of the coil and the direction in which the external electrodes are connected are parallel has been proposed. In this structure, parasitic capacitance is mainly formed between internal electrode conductors, and is rarely formed between internal and external electrodes, increasing a self-resonance frequency (SRF) of the inductor and greatly enhancing RF Q characteristics.

However, since the inner area of the coil may be small and a turn (or winding) number of coil may be large, the coil itself may be relatively inefficient, and since DC resistance Rdc may be high, the corresponding inductor cannot be properly used in a product requiring high current characteristics.

Thus, as an alternative, a structure in which the central axis of the coil is provided in parallel to the direction in which the external electrodes are extendedly connected and in which the central axis of the coil and a lamination direction of via conductors are perpendicular, has been proposed. In this structure, however, via holes must be created in every green sheet, and must be relatively large in order to implement a low DC resistance value, for which, thus, relatively expensive facilities are required, thus degrading productivity.

### SUMMARY OF THE INVENTION

An aspect of the present invention provides a multilayered ceramic electronic component having excellent DC resistance and impedance characteristics and a method of fabricating the same at low cost and with high productivity.

According to an aspect of the present invention, there is provided a multilayered ceramic electronic component including: a ceramic main body; external electrodes formed on an outer surface of the ceramic main body; and inner conductors forming a structure of a coil within the ceramic main body, wherein a central axis of the coil is in parallel to the direction in which the external electrodes are connected, and the inner conductors include via conductors laminated to be perpendicular to the central axis of the coil and a ratio of the area of one face of the via conductor to the area of the other face of the via conductor ranges from 0.9 to 1.1.

When the multilayered ceramic electronic component is viewed as projected in a lamination direction of the via conductors, the via conductors may have a quadrangular or circular shape.

When the multilayered ceramic electronic component is viewed in the direction of the central axis of the coil, the coil may have a quadrangular shape.

The ceramic main body may include a magnetic material, the magnetic material may include a ferrite material, and the ferrite material may include nickel-zinc-copper ferrite.

The inner conductors may include one or more selected from the group consisting of gold, silver, copper, nickel, palladium, and an alloy thereof.

According to another aspect of the present invention, there is provided a method of fabricating a multilayered ceramic electronic component, including: a first operation of printing a ceramic paste to prepare a ceramic green sheet; a second operation of printing a first conductive paste on the ceramic green sheet to form a plurality of first conductors and printing the ceramic paste on portions, other than the first conductors, of the ceramic green sheet; a third operation of printing a second conductive paste on the ceramic green sheet to form first via conductors such that they are connected to both ends of the plurality of first conductors, and printing the ceramic paste on portions, other than the plurality of first via conductors, of the ceramic green sheet; a fourth operation of printing the second conductive paste on the ceramic green sheet to form a plurality of second via conductors at positions corresponding to the plurality of first via conductors, and printing the ceramic paste on portions, other than the plurality of second via conductors, of the ceramic green sheet; a fifth operation of printing the first conductive paste on the ceramic green sheet to form a plurality of second conductors such that they are connected to the plurality of second via conductors, and printing the ceramic paste on portions, other than the plurality of second conductors, of the ceramic green sheet; and a sixth operation of printing the ceramic paste on the ceramic green sheet.

The ceramic paste may include a magnetic material.

The magnetic material may include ferrite.

The ferrite may include nickel-zinc-copper ferrite.

The first and second conductive pastes may include one or more selected from the group consisting of gold, silver, copper, nickel, palladium, and an alloy thereof.

The first and second conductive pastes may include the same material.

The first and second conductors may have a band-like shape.

The method may further include forming columnar via conductors by repeatedly performing the fourth operation, before the fifth operation.

A ratio of the area of the other face of the via conductor to the area of one face of the via conductor in the lamination direction of the via conductors may range from 0.9 to 1.1.

When the multilayered ceramic electronic component is viewed as projected in a lamination direction of the via conductors, the via conductors may have a quadrangular or circular shape.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an external perspective view of a multilayered ceramic electronic component according to an embodiment of the present invention;

FIG. 2 is an exploded perspective view of a multilayered ceramic electronic component according to an embodiment of the present invention;

FIG. 3 is a projected perspective view of a multilayered ceramic electronic component according to an embodiment of the present invention;

FIG. 4 is a plan view of via conductors according to an embodiment of the present invention;

FIG. 5 is a schematic view of the via conductors according to an embodiment of the present invention;

FIG. 6 is a flow chart illustrating a fabrication process of a multilayered ceramic electronic component according to an embodiment of the present invention;

FIG. 7 is a schematic view of a fabrication process of the via conductors according to an embodiment of the present invention; and

FIG. 8 is a schematic view of a fabrication process of the multilayered ceramic electronic component according to an embodiment of the present invention.

### DETAILED DESCRIPTION OF THE INVENTION

Embodiments of the present invention will now be described in detail with reference to the accompanying drawings.

The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like components.

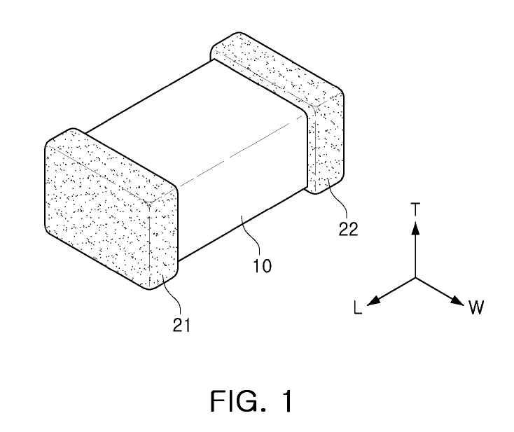

A multilayered ceramic electronic component according to an embodiment of the present invention will be described with reference to FIGS. 1 through 3.

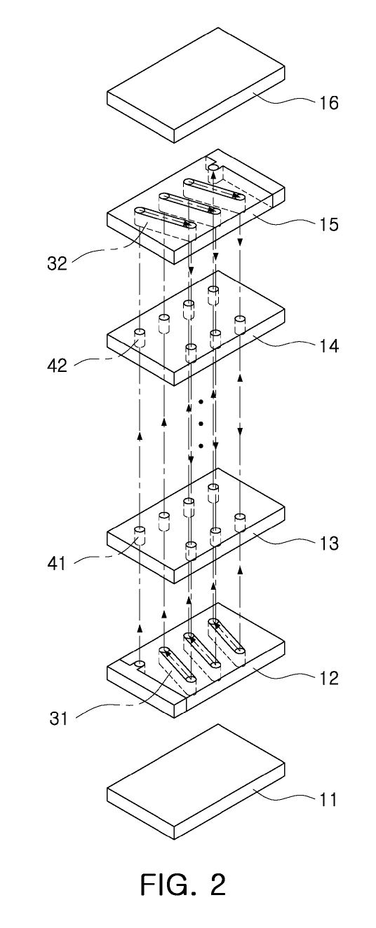

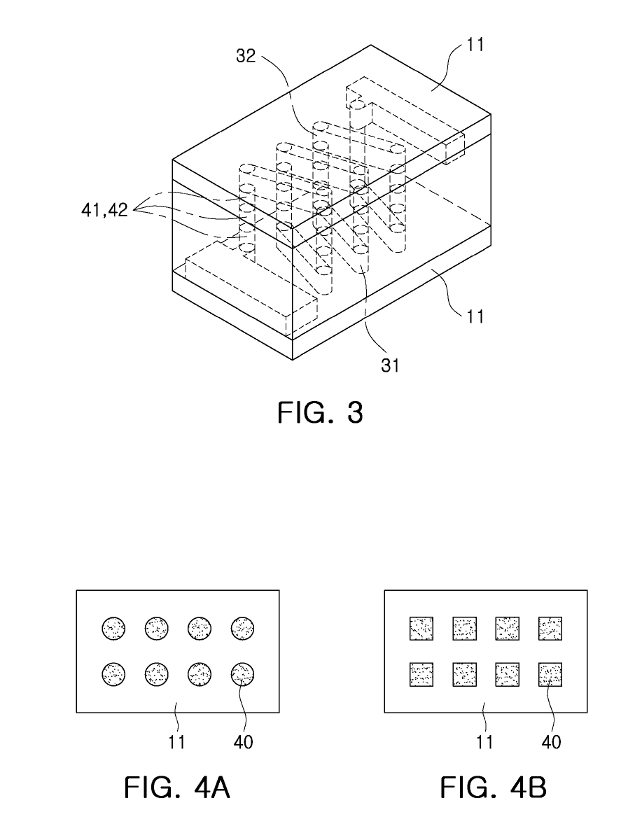

FIG. 1 is an external perspective view of a multilayered ceramic electronic component according to an embodiment of the present invention. FIG. 2 is an exploded perspective view of a multilayered ceramic electronic component according to an embodiment of the present invention. FIG. 3 is a projected perspective view of a multilayered ceramic electronic component according to an embodiment of the present invention.

A multilayered ceramic electronic component may include a multilayered ceramic capacitor, a multilayered chip inductor, multilayered chip beads, and the like. Hereinafter, a multilayered chip inductor will be described as an example, but the present invention is not limited thereto.

The present embodiment may include a ceramic main body 10, external electrodes 21 and 22, and inner conductors 31, 32, 41, and 42.

With reference to FIG. 1, the ceramic main body 10 may have a rectangular parallelepiped shape. It may be defined that a ‘lengthwise direction’ is an ‘L’ direction, a ‘widthwise direction’ is a ‘W’ direction, and a ‘thicknesswise direction’ is a ‘T’ direction. Here, the ‘thicknesswise direction’ may be used to have the same concept as a direction in which ceramic layers are piled up (or stacked), namely, ‘lamination direction’.

The ceramic main body 10 may include a magnetic material having relatively high magnetic permeability, and as the magnetic material, a ferrite-based material, specifically, nickel-copper-zinc-ferrite, may be used, but the present invention is not limited thereto.

The ceramic main body 10 may be formed by laminating a plurality of ceramic layers and sintering them. The plurality of ceramic layers may be integrated such that it may be difficult to discriminate a boundary between adjacent ceramic layers.

The external electrodes 21 and 22 may be formed to face each other on outer surfaces of the ceramic main body 10.

The external electrodes 21 and 22 may be formed by using conductive paste including a conductive metal. The conductive metal may include gold, silver, copper, nickel, palladium, and their alloy, or the like, but the present invention is not limited thereto.

With reference to FIGS. 2 and 3, the inner conductors may include via conductors 41 and 42 and first and second conductors 31 and 32.

The inner conductors 31, 32, 41, and 42 may be formed within the ceramic main body 10 and may be disposed to have a coil shape.

Since the inner conductors are disposed to have a coil shape, when a current flows across the inner conductors, a magnetic field may be induced in the vicinity of the inner conductors 31, 32, 41, and 42, so the inner conductors may serve as an inductor.

A central axis of the coil may be in parallel to the direction in which the external electrodes 21 and 22 are connected. Namely, the central axis of the coil may be in parallel to a lengthwise direction (L direction) of the ceramic main body 10.

In this structure, parasitic capacitance is largely formed only between the inner conductors 31, 32, 41, and 42, while parasitic capacitance formed between the inner conductors 31, 32, 41, and 42 and the external electrodes 21 and 22 is relatively very small, so the SRF of the inductor may be increased and the RF Q characteristics may be enhanced.

A plurality of via conductors 41 and 42 may be laminated to form via columns, and a lamination direction of the via conductors 41 and 42 may be perpendicular to the central axis of the coil.

FIG. 4 is a plan view of the via conductors 41 and 42 according to an embodiment of the present invention.

With reference to FIG. 4, a planar shape of the via conductors 41 and 42 may be a quadrangular shape or a circular shape.

FIG. 4A shows a case in which the via conductors 41 and 42 have a circular planar shape, and FIG. 4B shows a case in which the via conductors 41 and 42 have a quadrangular planar shape.

When the via conductors 41 and 42 have a quadrangular planar shape, they have a larger sectional area than that of the circular planar shape, further reducing series resistance of the via conductors 41 and 42.

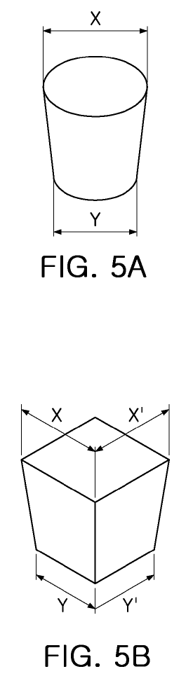

FIG. 5 is a schematic view of the via conductors 41 and 42 according to an embodiment of the present invention;

With reference to FIG. 5B, when the section of the via conductors 41 and 42 has a quadrangular shape, the ratio (Y/X, Y′/X′) of the length (Y or Y′) of a lower face of the via conductors 41 and 42 to the length (X or X′) of an upper face of the via conductors 41 and 42 may range from 0.9 to 1.1.

It is most ideal when the ratio of the length (Y or Y′) of the lower face of the via conductors 41 and 42 to the length (X or X′) of the upper face of the via conductors 41 and 42 is 1.0, because the passage through which a current flows is the relatively widest. However, it is difficult to implement the ratio due to a fabrication process error.

When the ratio of the length (Y or Y′) of the lower face of the via conductors 41 and 42 to the length (X or X′) of the upper face of the via conductors 41 and 42 is less than 0.9, the passage through which the current flows is relatively small, so series resistance may be excessively increased.

When the ratio of the length (Y or Y′) of the lower face of the via conductors 41 and 42 to the length (X or X′) of the upper face of the via conductors 41 and 42 is more than 1.1, similarly, the passage through which the current flows may be relatively small, increasing the series resistance. The reason is because it is the same when the upper and lower faces of the via conductors 41 and 42 are interchanged.

With reference to FIG. 5A, when the sectional shape of the via conductors 41 and 42 is a circular shape, the ratio (Y/X) of the diameter Y of the lower face of the via conductors 41 and 42 to the diameter X of the upper face of the via conductors 41 and 42 may range from 0.9 to 1.1.

Comparing to the case in which the sectional shape of the via conductors 41 and 42 is a quadrangular shape, the other conditions are the same except that the length is changed to be diameter.

When projected in the direction of the central axis of the coil, the coil may have a quadrangular shape.

The coil is formed by laminating the via conductors 41 and 42, so it is substantially difficult to fabricate a circular coil shape.

In case of fabricating a circular coil shape, the positions of the neighboring via conductors 41 and 42 should deviate from each other, having a possibility in which the via conductors 41 and 42 may be disconnected.

Thus, in order to prevent this, a via pad (not shown) may be additionally formed between the via conductors 41 and 42, but in this case, since an additional process is required, increasing the fabrication cost, and the possibility in which the electrical connection between the via conductors 41 and 42 is cut off may remain.

The inner conductors 31, 32, 41, and 42 are not particularly limited so long as they are formed of a material having electrical conductivity. Here, however, in consideration of the fact that they are sintered within the ceramic, a conductive metal having relatively high melting point may be used.

In detail, the inner conductors 31, 32, 41, and 42 may be formed of any one selected from the group consisting of gold, silver, copper, nickel, palladium, and an alloy thereof.

Hereinafter, a method of fabricating a multilayered ceramic electronic component according to another embodiment of the present invention will be described.

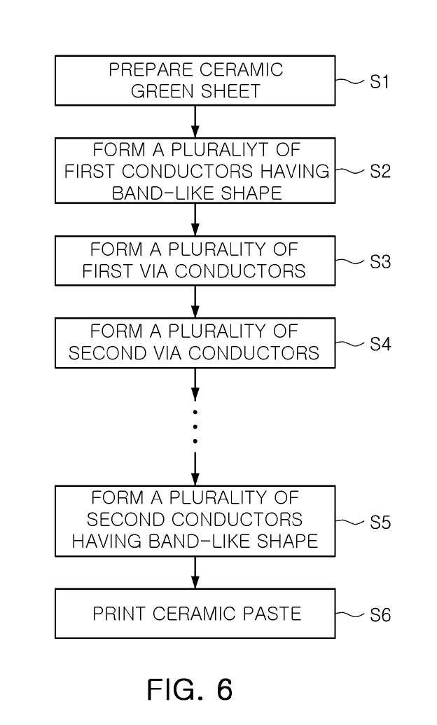

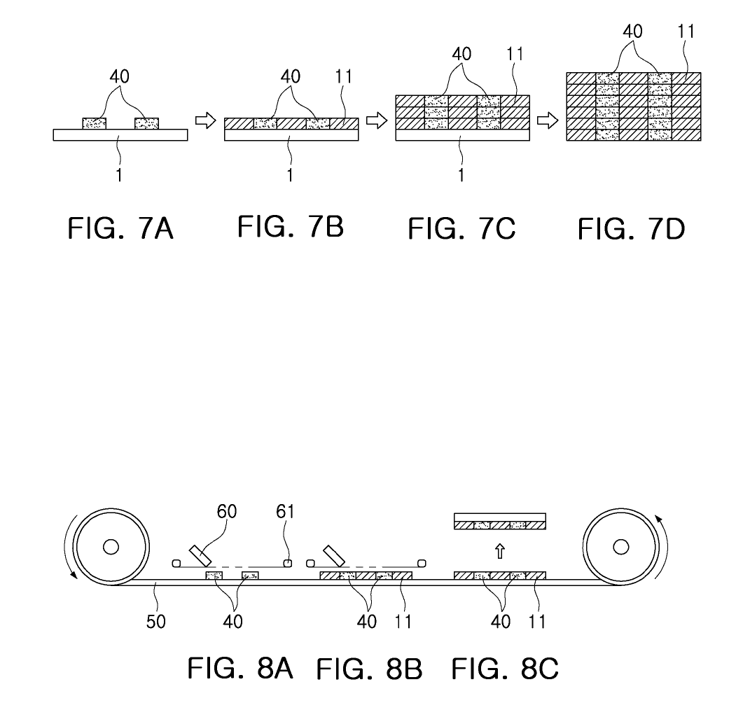

FIG. 6 is a flow chart illustrating a fabrication process of a multilayered ceramic electronic component according to an embodiment of the present invention. FIG. 7 is a schematic view of a fabrication process of the via conductor according to an embodiment of the present invention. FIG. 8 is a schematic view of a fabrication process of the multilayered ceramic electronic component according to an embodiment of the present invention.

With reference to FIGS. 3 and 6, the method of fabricating a multilayered ceramic electronic component is as follows.

In a first operation S1, ceramic paste may be printed to prepare a ceramic green sheet 11.

First, an organic solvent, a binder, and the like, may be mixed with ceramic powder and ball-milled to fabricate a ceramic paste in which ceramic powder is evenly distributed.

The ceramic paste may be printed on a polymer film such as polyethylene or the like through a method such as screen printing, or the like, and then dried to prepare the ceramic green sheet 11.

In a second operation (S2), a first conductive paste may be printed on the ceramic green sheet 11 to form a plurality of first conductors 31 and a ceramic paste may be printed on portions, other than the first conductors 31, of the ceramic green sheet 11.

The first conductive paste is different from the ceramic paste, in that the first conductive paste includes a conductive metal, rather than ceramic powder, and may be prepared in the same manner as that of the ceramic paste. In this case, the content of an organic solvent, a binder, and the like, may be different in order to adjust viscosity, or the like.

The first conductive paste may be screen-printed to form a plurality of first conductors 31 on the ceramic green sheet 11. The thickness of the first conductors 31 may be adjusted by adjusting the repetition number of screen printing, and as the thickness of the first conductors 31 is increased, the DC resistance Rdc may be reduced.

The ceramic paste may be again printed on portions, other than the regions where the first conductors 31 are formed, to form a ceramic region. Accordingly, the ceramic green sheet 12 having the first conductors 31 formed on a central portion of the ceramic region may be obtained.

In a third operation (S3), a second conductive paste may be printed on the ceramic green sheet 12 to form first via conductors 41 such that the first via conductors 41 are connected to both ends of the plurality of first conductors 31, and the ceramic paste may be printed on portions, other than the plurality of first via conductors 41, of the ceramic green sheet 12.

The first via conductors 41 may be printed such that they correspond to both ends of the first conductors 31. The thickness of the first via conductors 41 may be adjusted according to the number of printing.

The ceramic paste may be printed on portions, other than the first via conductors 41, of a ceramic green sheet 13 are formed, to form a ceramic region, and accordingly, the via conductors 41 may be exposed from the ceramic green sheet 13.

Since the via conductors 41 are formed through printing, the dimension of the upper and lower faces of the via conductors 41 may be maintained to be substantially same, and accordingly, the DC resistance Rdc of the laminated via conductors 41 may be significantly reduced.

In a case in which the dimensions of the areas of the upper and lower faces of the via conductors 41 are different, since the passage through which a current flows is determined by the upper and lower faces having a relatively small area, the passage through which the current flows may be reduced.

Thus, the areas of the upper and lower faces of the via conductors 41 are maintained to be equal to thereby reduce the DC resistance.

In case in which via holes are first formed and buried by conductive paste, it may be difficult to form the via conductors such that the areas of the upper and lower faces thereof are equal. It may be difficult to form the via holes to have the regular dimensions, and it may be also difficult to form the via holes such that the dimensions thereof are regular, due to an error in the fabrication process in burying the via holes with the conductive paste.

Thus, there may be a limitation in reducing the DC resistance in the case in which the via holes are first formed and buried by the conductive paste.

In the present embodiment, in order to solve such a defect, the via conductors 41 and 42 may be first formed, and portions, other than the regions where the via conductors 41 and 42 are formed, may be printed with ceramic paste to form a ceramic region, and accordingly, the dimensions of the via conductors 41 and 42 may be stable.

Namely, the areas of the upper and lower faces of the via conductors 41 and 42 are equal, thereby significantly reducing the DC resistance of the via conductors 41 and 42.

In a fourth operation S4, a second conductive paste may be printed on the ceramic green sheet 13 to form a plurality of second via conductors 42 at positions corresponding to the plurality of first via conductors 41, and the ceramic paste may be printed on portions, other than the plurality of second via conductors 42, of the ceramic green sheet.

The fourth operation is a process of forming via columns, and in this operation, the second via conductors 42 may be formed by printing the second conductive paste such that the second via conductors 42 correspond to the already formed via conductors 41. The ceramic paste may be printed on the portions, other than the regions where the second via conductors 42 are formed, to form a ceramic region.

Via columns having a required height may be formed by repeatedly performing the fourth operation several times.

A structure, in which ‘U’-shaped conductors are disposed side by side by the first conductors 31 and the columnar via conductors 41 and 42, and the respective U-shaped conductors are separated, may be provided.

In the fifth operation S5, the first conductive paste may be printed on the ceramic green sheet 14 to form the plurality of second conductors 32 such that they are connected to the plurality of second via conductors 42, and the ceramic paste may be printed on portions, other than the regions where the plurality of second conductors are formed, of the ceramic green sheet 14.

The second conductors 32 may be formed such that both ends thereof are connected to the already formed via conductors 42. The second conductors 32 may be formed by printing the first conductive paste.

The second conductors 32 may serve as a helical coil by electrically connecting the U-shaped conductors formed in the fourth operation.

When the fifth operation is finished, the coil may be completed.

In the sixth operation S6, the ceramic paste may be printed on the ceramic green sheet 15.

Here, the ceramic paste may be printed to completely cover the plurality of second conductors 32 which have been already formed, thus protecting the second conductors 32 against the outside.

Unlike the case as described above, the first operation may not be performed.

With reference to FIG. 7, only the second to fifth operations may be performed on a base 1 formed of a polymer resin, or the like, to form columnar laminated vias, and the base 1 may be eliminated and then, a ceramic paste may be printed on upper and lower faces thereof.

Also, with reference to FIG. 8, the columnar laminated via conductors may be continuously fabricated according to a roll-to-roll technique. The second operation S2 to fifth operation S5 of FIG. 6 may be performed in an intermediate process of continuously unwinding and winding the base film to form the columnar laminated via conductors.

The ceramic paste may include a magnetic material. The magnetic material may include ferrite. The ferrite may include nickel-zinc-copper ferrite.

The first and second conductive pastes may include any one or more selected from the group consisting of gold, silver, copper, nickel, palladium, and an alloy thereof.

The first and second conductive pastes may include the same material.

The first and second conductors may be formed using the first conductive paste, and the plurality of via conductors may be formed using the second conductive paste, whereby since the first and second conductive pastes are the same, the mechanical connection and electrical connection between the first and second conductors and the via conductors may be more stable.

The first and second conductors may have a band-like shape.

The method may further include an operation of forming columnar via conductors by repeatedly performing the fourth operation, before the fifth operation.

The ratio of the area of the other face of the via conductor to the area of one face of the via conductor in the lamination direction of the via conductors may range from 0.9 to 1.1.

When the multilayered ceramic electronic component is viewed as projected in a lamination direction of the via conductors, the via conductors may have a quadrangular or circular shape.

The ceramic may be any one of a magnetic material, a glass material, and a dielectric material.

Matters related to the via conductors and the ceramic material are the same as those described above.

### Example

The present invention will be described in detail with reference to specific Examples.

First, nickel-zinc-copper ferrite powder, ethanol as an organic solvent, ethylcellulose as a binder were mixed and 3-roll milling was performed thereon to prepare a ceramic paste, and also, a conductive paste including silver (Ag) powder was prepared.

Next, the ceramic paste was screen-printed on a polyethylene film to fabricate a ceramic green sheet, and then, the ceramic green sheet was dried.

And then, seven first conductors having a band-like shape were formed on the ceramic green sheet by using the conductive paste, and the ceramic paste was printed on portions other than the band-shaped conductors to form a ceramic region.

The conductive paste was printed to form via conductors such that the via conductors correspond to both ends of the seven band-shaped conductors, and the ceramic paste was printed on portions other than the via conductors to form a ceramic region.

The via conductors were formed such that a section thereof has a square shape of which one side is 50 um.

This process was repeatedly performed ten to forty times to form via conductor columns.

Thereafter, a plurality of second conductors having a band-like shape were printed so as to be connected with the via conductors to form a coil structure.

And then, the ceramic paste was printed to cover the second conductors.

A DC resistance value of the multilayered inductor fabricated according to the foregoing fabrication method was measured.

DC resistance thereof was measured by using Agilent 4338B milliohmmeter.

Comparative Examples were performed by using the same method as that of Examples, except that via holes were formed on a ceramic green sheet and buried with a conductive paste to form via conductors, and then, the via conductors were laminated to form via columns.

The measurement results of DC resistance Rdc of Examples and Comparative Example are shown in Table 1.

In case of Comparative Examples, the ratios of the length of the lower face of the via conductor to the length of the upper face of the via conductor were adjusted to be 0.7, 0.8, 1.2, and 1.3, respectively.

In case of Examples, the ratio of the length of the lower face of the via conductor to the length of the upper face of the via conductor ranged from 0.95 to 1.05.

TABLE 1

| | | | | DC resistance |
|---|---|---|---|---|
| Classification | X (um) | Y (um) | Y/X | (Rdc) |
| Comparative | 43 | 60 | 0.7 | 1.4 |
| Example 1 | | | | |
| Comparative | 50 | 62 | 0.8 | 1.25 |
| Example 2 | | | | |
| Example 1 | 52 | 58 | 0.9 | 1.15 |
| Example 2 | 53 | 54 | 1.0 | 1.10 |
| Example 3 | 55 | 49 | 1.1 | 1.11 |
| Comparative | 58 | 48 | 1.2 | 1.22 |
| Example 3 | | | | |
| Comparative | 60 | 45 | 1.3 | 1.34 |
| Example 4 | | | | |

In Table 1, X denotes the length of the upper face of the via conductor, Y denotes the length of the lower face of the via conductor, and Y/X is the ratio of the length of the lower face of the via conductor to the length of the upper face of the via conductor.

With reference to Table 1, in Comparative Examples 1 and 2, Y/X is [0.7] and [0.8], Rdc value is [1.4] and [1.25], respectively. In Examples 1, 2, and 3, Y/X is [0.9], [1.0], [1.1], and Rdc value is [1.15], [1.10], and [1.11], respectively.

In Comparative Examples 3 and 4, Y/X is [1.2] and [1.3], and Rdc value is [1.22] and [1.34], respectively.

According to the results of Table 1, it is noted that Rdc value is relatively small when Y/X is [0.9], [1.0], and [1.1].

As set forth above, according to embodiments of the invention, a multilayered ceramic electronic component which has excellent DC resistance characteristics and impedance characteristics and which is low-priced and has high productivity may be obtained.

While the present invention has been shown and described in connection with the embodiments, it will be apparent to those skilled in the art that modifications and variations may be made without departing from the spirit and scope of the invention as defined by the appended claims.

What is claimed is:

1. A multilayered ceramic electronic component comprising:
a ceramic main body;
external electrodes formed on an outer surface of the ceramic main body; and
inner conductors forming a structure of a coil within the ceramic main body,
a central axis of the coil being in parallel to the direction in which the external electrodes are connected, and the inner conductors including via conductors laminated to be perpendicular to the central axis of the coil, and a ratio of the area of one face of the via conductor to the area of the other face of the via conductor ranging from 0.9 to 1.1.

2. The multilayered ceramic electronic component of claim 1, wherein when the multilayered ceramic electronic component is viewed as projected in a lamination direction of the via conductors, the via conductors have a quadrangular or circular shape.

3. The multilayered ceramic electronic component of claim 1, wherein when the multilayered ceramic electronic component is viewed in the direction of the central axis of the coil, the coil has a quadrangular shape.

4. The multilayered ceramic electronic component of claim 1, wherein the ceramic main body includes a magnetic material.

5. The multilayered ceramic electronic component of claim 4, wherein the magnetic material includes a ferrite material.

6. The multilayered ceramic electronic component of claim 5, wherein the ferrite material includes nickel-zinc-copper ferrite.

7. The multilayered ceramic electronic component of claim 1, wherein the inner conductors include one or more selected from the group consisting of gold, silver, copper, nickel, palladium, and an alloy thereof.

8. A method of fabricating a multilayered ceramic electronic component, the method comprising:
a first operation of printing a ceramic paste to prepare a ceramic green sheet;
a second operation of printing a first conductive paste on the ceramic green sheet to form a plurality of first conductors and printing the ceramic paste on portions, other than the first conductors, of the ceramic green sheet;
a third operation of printing a second conductive paste on the ceramic green sheet to form first via conductors such that they are connected to both ends of the plurality of first conductors, and printing the ceramic paste on portions, other than the plurality of first via conductors, of the ceramic green sheet;
a fourth operation of printing the second conductive paste on the ceramic green sheet to form a plurality of second via conductors at positions corresponding to the plurality of first via conductors, and printing the ceramic paste on portions, other than the plurality of second via conductors, of the ceramic green sheet;
a fifth operation of printing the first conductive paste on the ceramic green sheet to form a plurality of second conductors such that they are connected to the plurality of second via conductors, and printing the ceramic paste on portions, other than the plurality of second conductors, of the ceramic green sheet; and
a sixth operation of printing the ceramic paste on the ceramic green sheet.

9. The method of claim 8, wherein the ceramic paste includes a magnetic material.

10. The method of claim 9, wherein the magnetic material includes ferrite.

11. The method of claim 10, wherein the ferrite includes nickel-zinc-copper ferrite.

12. The method of claim 8, wherein the first and second conductive pastes include one or more selected from the group consisting of gold, silver, copper, nickel, palladium, and an alloy thereof.

13. The method of claim 8, wherein the first and second conductive pastes include the same material.

14. The method of claim 8, wherein the first and second conductors have a band-like shape.

15. The method of claim 8, further comprising forming columnar via conductors by repeatedly performing the fourth operation, before the fifth operation.

16. The method of claim 8, wherein a ratio of the area of the other face of the via conductor to the area of one face of the via conductor in the lamination direction of the via conductors ranges from 0.9 to 1.1.

17. The method of claim 8, wherein when the multilayered ceramic electronic component is viewed as projected in a lamination direction of the via conductors, the via conductors have a quadrangular or circular shape.
